(19) United States
(12) Patent Application Publication
(10) Pub. No.: US 2026/0303743 A1
(43) Pub. Date: Oct. 1, 2026

(54) INFORMATION PROCESSING APPARATUS AND PROCESSING METHOD OF INFORMATION PROCESSING APPARATUS

(71) Applicant: CANON KABUSHIKI KAISHA, Tokyo (JP)

(72) Inventor: MOTOKI KOSHIGAYA, Saitama (JP)

(21) Appl. No.: 19/629,608

(22) Filed: Mar. 26, 2026

(30) Foreign Application Priority Data
Mar. 28, 2025 (JP) 2025-055695

(51) Int. Cl. H04N 1/00

(52) U.S. Cl. CPC H04N 1/00907; H04N 1/00891; H04N 1/00901

(57) ABSTRACT

An information processing apparatus includes a first system circuit configured to be connected to a first power supply path, a second system circuit configured to be connected to the first power supply path, and configured to be connected to the first system circuit via a signal line, a first display unit configured to be connected to a second power supply path different from the first power supply path, and configured to perform display in a state where the first system circuit is not activated and cancel display in a state where the first system circuit is activated, and a second display unit configured to be connected to the second power supply path, and configured to perform display in a state where the second system circuit is not activated and cancel display in a state where the second system circuit is activated.

### BACKGROUND

### Field of the Technology

The present disclosure relates to an information processing apparatus and a processing method of the information processing apparatus.

### Description of the Related Art

Conventional information processing apparatuses, for example, image forming apparatuses such as multi function printers (MFPs) having complicated configurations have been generally repaired and maintained by dealers and service engineers. However, recent years have seen an increase in assertive movements for "Right to repair". Continuing to use products through repairs has a favorable effect on sustainability (Sustainable Development Goals or SDGs) and recycle-based economy (Green Transformation or GX). Generally, in many cases, users lack knowledge because they are not experienced unlike service engineers. There has been a necessity that manufacturers prepare a system for enabling users to repair products.

Japanese Patent Laid-Open No. 2019-191852 discloses a fault diagnostic technique based on a diagnostic apparatus for identifying a defective portion by analyzing the degree of abnormality based on input/output data of each part, and displaying analyzed fault information as an alarm on a display unit.

However, the fault diagnostic technique described in Japanese Patent Laid-Open No. 2019-191852 premises the activation of a basic system. If the basic system is not activated and a notification unit does not sufficiently operate (for example, a display screen displays nothing or blacks out), the defective portion cannot be notified. Particularly with an image forming apparatus including a plurality of units of electrically controlled components, a user finds it difficult to identify which substrate or wiring is defective, depending on the trouble state. Further, depending on the cause of failure, replacing a wrong component induces the same cause of failure, possibly causing a damage to a new component again.

### SUMMARY

According to an aspect of the present disclosure, an information processing apparatus includes a first system circuit configured to be connected to a first power supply path, a second system circuit configured to be connected to the first power supply path and configured to be connected to the first system circuit via a signal line, a first display unit configured to be connected to a second power supply path different from the first power supply path, and configured to perform display in a state where the first system circuit is not activated and cancel display in a state where the first system circuit is activated, and a second display unit configured to be connected to the second power supply path, and configured to perform display in a state where the second system circuit is not activated and cancel display in a state where the second system circuit is activated.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of an image forming apparatus.

FIG. 2 is a perspective diagram illustrating the image forming apparatus.

FIG. 3 is a block diagram illustrating an example configuration of the image forming apparatus.

FIG. 4 is a block diagram illustrating an example configuration of an operation panel.

FIG. 5 illustrates an example of an electrical diagram of the image forming apparatus.

FIG. 6 illustrates an example of an internal electrical diagram of an abnormality display apparatus.

FIG. 7 illustrates an example configuration of the abnormality display apparatus.

FIG. 8 is a flowchart illustrating processing for controlling a signal line according to one or more aspects of the present disclosure.

FIG. 9 illustrates examples of judgments in selecting replacement parts from an abnormal state when power is ON according to one or more aspects of the present disclosure.

FIG. 10 illustrates examples of judgments in selecting replacement parts from an abnormal state when power is OFF.

FIG. 11 is a flowchart illustrating processing for controlling a signal line and a connection signal line according to one or more aspects of the present disclosure.

FIG. 12 illustrates examples of judgments in selecting replacement parts from an abnormal state when power is ON according to one or more aspects of the present disclosure.

### DESCRIPTION OF THE EMBODIMENTS

Desirable embodiments of the present disclosure will be described as illustrative in detail below with reference to the accompanying drawings. Sizes, materials, shapes, and relative arrangements of components described in the following embodiments are not limited thereto. Unless otherwise specifically described, the scope of the present disclosure is not limited to the embodiments.

### First Embodiment

### Image Forming Apparatus

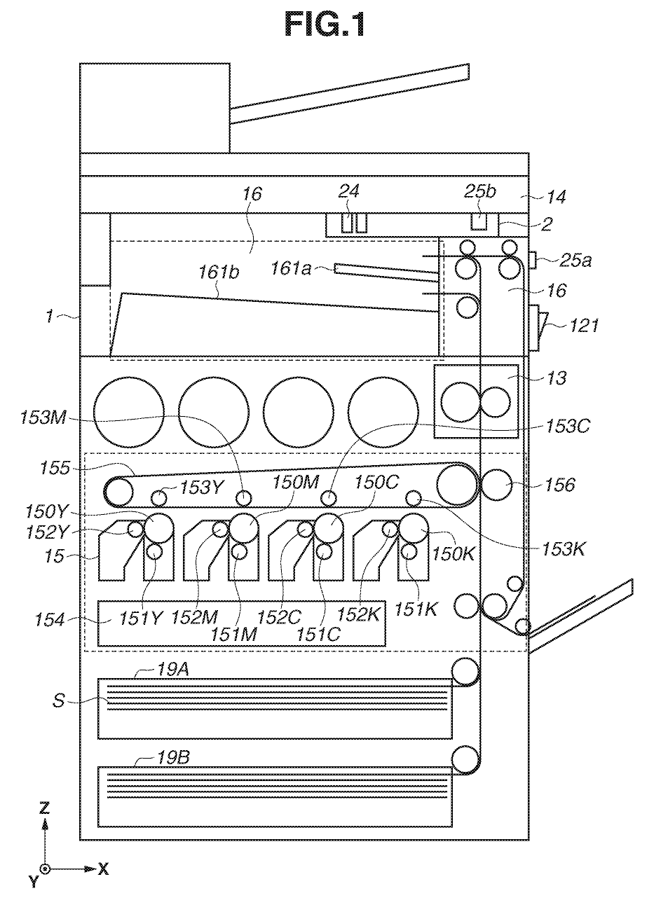

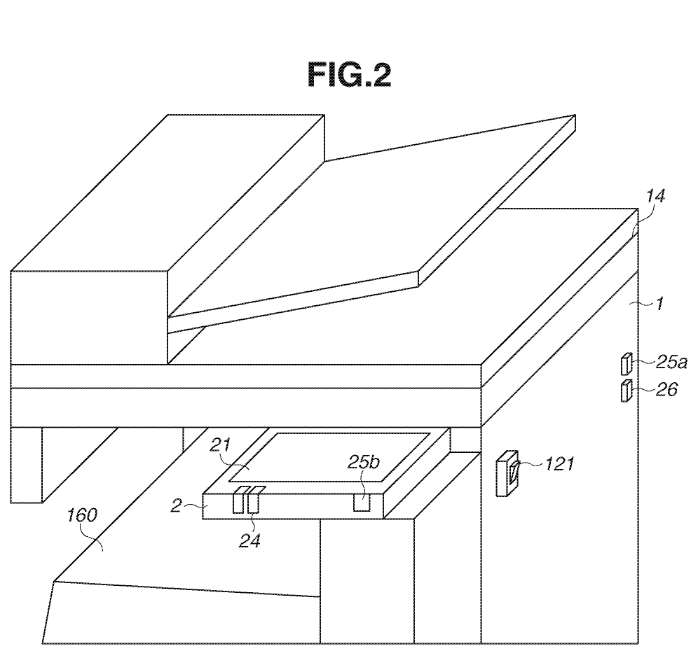

An image forming apparatus 1 according to a first embodiment will be described below with reference to FIGS. 1 and 2. FIG. 1 illustrates an example of the image forming apparatus 1. FIG. 2 is an enlarged view illustrating the periphery of an operation panel 2 of the image forming apparatus 1.

As illustrated in FIG. 1, the image forming apparatus 1 for forming an image on a sheet S includes a reader 14 for optically reading an image of a document placed on a glass plate (not illustrated) and converting the image into image data. The image forming apparatus 1 can be additionally provided with a processing apparatus 16 for applying staple processing, punch processing, bookbinding processing, and the like to the sheet S with an image formed thereon by the image forming apparatus 1.

The image forming apparatus 1 includes an image forming unit 15 for forming an image on the sheet S. The image forming unit 15 includes photosensitive drums 150Y, 150M, 150C, and 150K, charging devices 151Y, 151M, 151C, and 151K, and development devices 152Y, 152M, 152C, and 152K.

The image forming unit 15 also includes primary transfer rollers 153Y, 153M, 153C, and 153K, a laser scanner unit 154, an intermediate transfer belt 155, and a secondary transfer roller 156.

When forming an image by using the image forming apparatus 1, an image forming job is input to a main body control unit 10. Thus, the sheet S stored in either one of sheet cassettes 19A and 19B is sent to a secondary transfer portion formed by the intermediate transfer belt 155 and the secondary transfer roller 156.

Meanwhile, in the image forming unit 15, the surface of the photosensitive drum 150Y is charged by the charging device 151Y. Then, the laser scanner unit 154 irradiates the surface of the photosensitive drum 150Y with a laser beam to form, on the surface of the photosensitive drum 150Y, an electrostatic latent image corresponding to the image data of the document read by the reader 14 or image data transmitted from an external apparatus (not illustrated) via a network.

Then, the development device 152Y applies a yellow toner to the electrostatic latent image formed on the surface of the photosensitive drum 150Y to form a yellow toner image on the surface of the photosensitive drum 150Y.

When the primary transfer roller 153Y is applied with a primary transfer bias, the toner images formed on the surface of the photosensitive drum 150Y are primarily transferred onto the intermediate transfer belt 155.

In a similar process, a magenta toner image, a cyan toner image, and a black toner image are also formed on the photosensitive drum 150M, 150C, and 150K, respectively. Then, when the primary transfer rollers 153M, 153C, and 153K are applied with the primary transfer bias, these toner images are transferred onto the yellow toner image on the intermediate transfer belt 155 in a superimposed way. Thus, a full-color toner image corresponding to an image signal is formed on the surface of the intermediate transfer belt 155.

Then, when the intermediate transfer belt 155 circularly moves, the full-color toner image is sent to the secondary transfer portion. Then, when the secondary transfer roller 156 is applied with a secondary transfer bias at the secondary transfer portion, the full-color toner image on the intermediate transfer belt 155 is transferred onto the sheet S. The sheet S with the toner image transferred thereto is conveyed to a fixing device 13. Then, the fixing device 13 applies heating and pressurizing processing to the sheet S to fix the toner image to the sheet S.

Then, the sheet S with the toner image fixed thereto is sent to the processing apparatus 16. If a user specifies staple processing, punch processing, bookbinding processing, or the like, the sheet S having been sent to the processing apparatus 16 is subjected to the specified processing and then discharged to a discharge tray 161a. If the user specifies no processing or if the processing apparatus 16 is not connected, the sheet S is subjected to no processing and then discharged as is to a discharge tray 161b. In the present disclosure, the discharge unit 160 includes a discharge tray 161a and a discharge tray 161b.

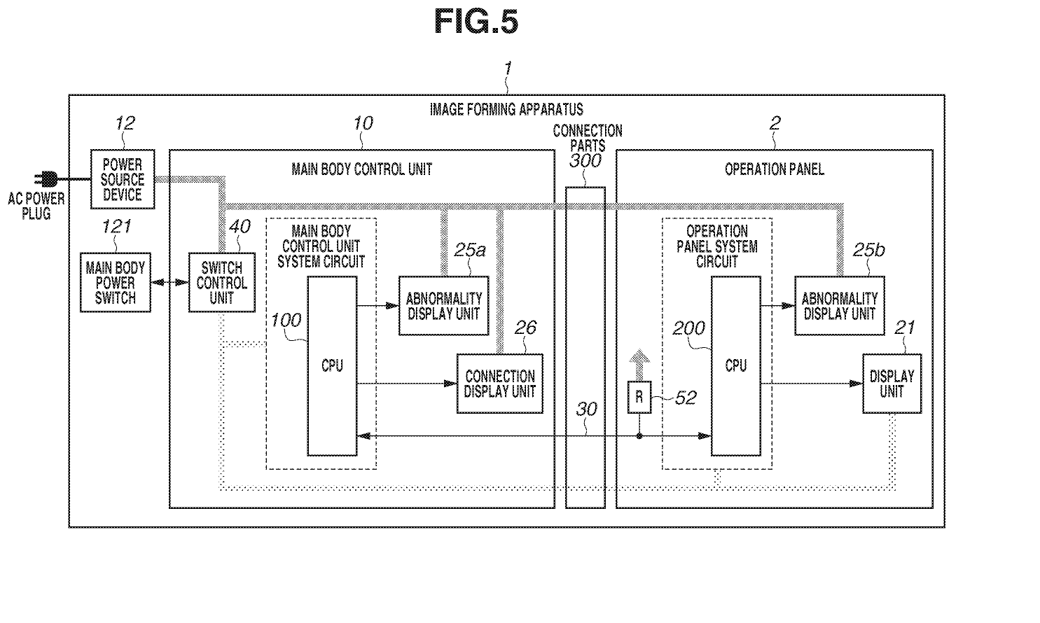

The image forming apparatus 1 is provided with a main body power switch 121 of the seesaw type or the tactile type for turning the main power ON or OFF. When the main body power switch 121 is turned ON, the image forming apparatus 1 starts system operations. However, to detect a signal for this switch, the electric circuit configuring the system is supplied with power when external alternating current (AC) power is connected to the AC power plug of the main body, as illustrated in FIG. 5 (described below). The power source is direct current (DC) power generated through the AC/DC conversion by the power source device 12.

The image forming apparatus 1 includes a display unit 21 for displaying a display image received from the image forming apparatus 1, and the operation panel 2 having a touch panel 22 for detecting user's touch operations.

The user performs an input operation by touching a key (input portion or button) displayed on the display unit 21 with a finger. This allows the user to make settings for image formation such as the number of images to be formed and the size of the sheet S, and make settings for image reading such as the document size. The operation panel 2 includes, in addition to the touch panel 22, a key operation input unit used by the user to make settings for the image forming apparatus 1 and issue a job instruction, and a status display unit 24 for informing the user of the status of the image forming apparatus 1 (job execution, paper jam and other errors). For example, if a jam occurs in the main body during paper feed in printing and then paper stops, if any component failure is suspected, or if the cover of the image forming apparatus 1 is open, the image forming apparatus 1 blinks or lights up the light emitting diode (LED) or the like of the status display unit 24 to notify the user of the status. In addition to the status display unit 24, the image forming apparatus 1 is provided with an abnormality display unit 25a (first display unit) and an abnormality display unit 25b (second display unit) to be referenced in the present embodiment. These display units are connected to the AC power plug of the main body provided separately from the system operation circuit. The display units include a circuit for enabling the display with the DC power generated by the power source device 12. Likewise, the image forming apparatus 1 is provided with a connection display unit 26 including a circuit for enabling the display with a separate power source. The operations of the abnormality display units 25a (first display unit), the abnormality display unit 25b (second display unit), and the connection display unit 26 will be described in detail below with reference to embodiments (described below).

### Configuration of Image Forming Apparatus

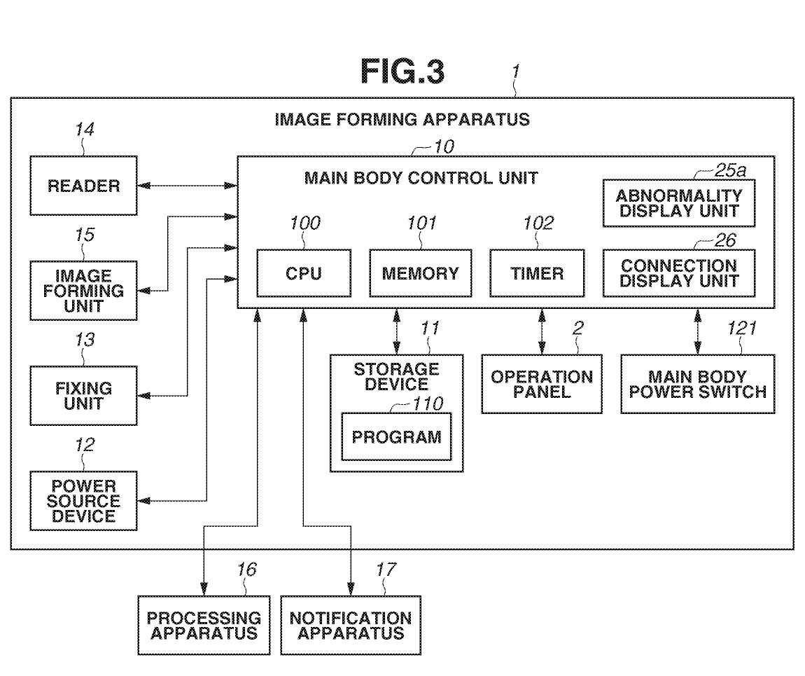

An example configuration of the image forming apparatus 1 will be described below with reference to FIG. 3. FIG. 3 is a block diagram illustrating an example configuration of the image forming apparatus 1.

As illustrated in FIG. 3, the image forming apparatus 1 includes the main body control unit 10 including a central processing unit (CPU) 100, a memory 101, and a timer 102. The main body control unit 10 is connected to a storage device 11, a reader 14, an image forming unit 15, an operation panel 2, and the like. The image forming apparatus 1 can be additionally connected to the processing apparatus 16 as an option aiming for the functional expansion. The main body control unit 10 (CPU 100) controls the operation of each connected component.

The reader 14 reads a document to generate image data. The image forming unit 15 performs image forming processing to form an image on a sheet based on the image data. The processing apparatus 16 applies staple processing, punch processing, bookbinding processing, and the like to a print product such as sheets having been subjected to the image forming processing. The notification apparatus 17 is a function expansion unit for notifying the user of the status of the image forming apparatus 1.

The storage device 11 stores various programs 110 for controlling the image forming apparatus 1, various display images, print data, and the like. Various programs 110 stored in the storage device 11 refer to a software group for causing the main body control unit 10 to perform various processing. Various display images stored in the storage device 11 are display images (image data) and the like to be displayed on the operation panel 2.

The CPU 100 reads the programs 110 stored in the storage device 11 and executes the programs 110. The CPU 100 also reads the display image to be displayed on the operation panel 2 from the storage device 11 and sends the image to the operation panel 2. The memory 101 temporarily stores data resulting from the execution of the programs 110 by the CPU 100. More specifically, based on the programs 110 stored in the storage device 11, the CPU 100 controls the reader 14, the image forming unit 15, the processing apparatus 16, the notification apparatus 17, a key input unit 18, and the like connected to the main body control unit 10, by using the memory 101 as a work area to subject a sheet to the image forming processing and the like. For example, the CPU 100 applies image processing to the image data read from a document by the reader 14, based on the programs 110.

The CPU 100 stores the thus-generated image data in the storage device 11, transfers the image data to the image forming unit 15, and performs the image forming processing. The main body of the image forming apparatus 1 is provided with a detection sensor for detecting the storage state of the operation panel 2, enabling the CPU 100 to control the operation panel 2 and the power source device 12 depending on the detection status of the detection sensor. The CPU 100 can turn OFF the power of the abnormality display unit 25a (first display unit), the abnormality display unit 25b (second display unit), and the connection display unit 26 controlled by a power source different from the power source on which the CPU 100 operates. The operations of the abnormality display unit 25a (first display unit) and the connection display unit 26 will be described in detail below with reference to embodiments.

The timer 102 is used to count time in various processing performed by the main body control unit 10. For example, the main body control unit 10 determines to cause the image forming apparatus 1 to make a transition from the standby mode to the sleep mode with a low power consumption, according to the count value of the timer 102.

The main body control unit 10 is also connected to the power source device 12. The power source device 12 is supplied with power from a commercial power source via an outlet plug 122, converts the power into power to be used by each device, and supplies the power to each device. Turning the main body power switch 121 ON and OFF controls the electrical connection of the power to be supplied to the system in the main body control unit 10. When an external AC power source is connected to the AC power plug of the main body, the abnormality display unit 25a (first display unit) and the connection display unit 26 are supplied with the DC power generated by the power source device 12.

### Configuration of Operation Panel

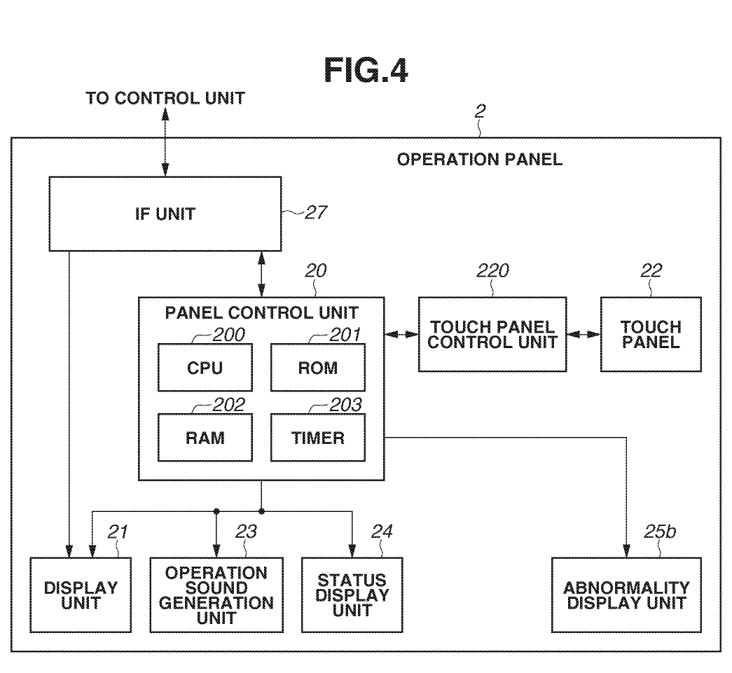

An example configuration of the operation panel 2 will be described below with reference to FIG. 4. FIG. 4 is a block diagram illustrating an example configuration of the operation panel 2.

As illustrated in FIG. 4, the operation panel 2 includes a panel control unit 20 including a CPU 200, a read only memory (ROM) 201, a random access memory (RAM) 202, and a timer 203. The timer 203 is used to count time in various processing performed by the panel control unit 20.

The ROM 201 stores data including various programs for controlling the operation panel 2. The CPU 200 performs various calculation processing based on control programs stored in the ROM 201. The RAM 202 temporarily stores data. More specifically, based on the control programs stored in the ROM 201, the CPU 200 controls the display unit 21, an operation sound generation unit 23, the status display unit 24, and the like connected to the panel control unit 20, by using the RAM 202 as a work area.

The ROM 201 is a storage device storing information about control (described below). The ROM 201 stores various programs and the like for controlling the operation panel 2 and information about connections with the image forming apparatus 1. The information about the control includes information about the establishment of the connection with the image forming apparatus 1 and information acquired from the image forming apparatus 1. The information acquired from the image forming apparatus 1 includes information about the status of the image forming apparatus 1, such as the standby mode, sleep mode, and error detection, and count information such as the number of printed sheets.

The display unit 21 can display information prestored in the ROM 201 and information received from the main body control unit 10. Therefore, the CPU 200 switches the image to be output to the display unit 21 between an image stored in the operation panel 2 and an image received from the main body control unit 10.

The touch panel 22, which is an operation unit for detecting user's touch operations, is stacked on the display unit 21. The user performs operations by touching the display unit 21 with a finger via the touch panel 22. The display unit 21 displays a screen to the user through the touch panel 22. The touch panel 22 is connected to the panel control unit 20 via the touch panel control unit 220, and detects the portion on the display unit 21 touched by the user. The CPU 200 calculates the coordinates of the touched position based on a signal detected by the touch panel control unit 220, and sends the coordinates to the main body control unit 10 of the image forming apparatus 1 via an interface unit (IF unit) 27. However, when the user operations are to be disabled, the CPU 200 does not send the coordinates to the main body control unit 10 of the image forming apparatus 1.

The operation panel 2 also includes the abnormality display unit 25b (second display unit). The CPU 200 can turn OFF the power of the abnormality display unit 25b (second display unit) controlled by a power source different from the power source on which the CPU 200 operates. The operation of the abnormality display unit 25b (second display unit) will be described in detail below with reference to embodiments.

The electric circuit included in the image forming apparatus 1 according to the first embodiment and its processing will be described below with reference to FIGS. 5-10.

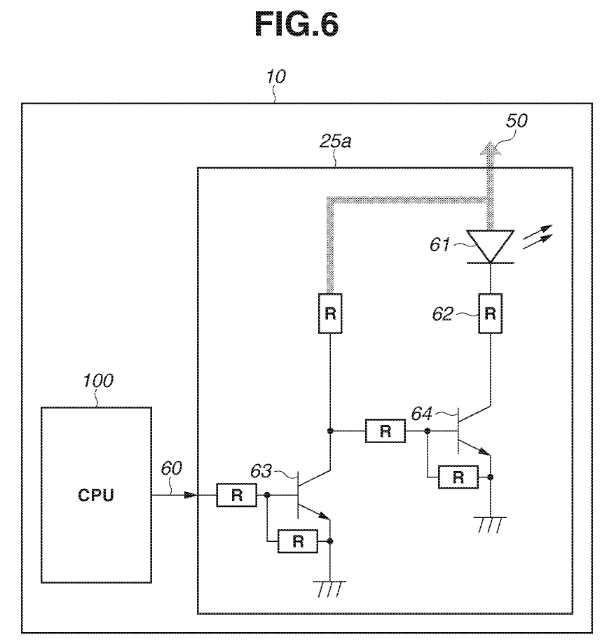

FIG. 5 illustrates an example configuration for supplying the power supplied from the power source device 12 in the image forming apparatus 1, to the main body control unit 10 and the operation panel 2. The main body control unit 10 is supplied with an upstream DC power supply path 50 that supplies power when an external AC power source is connected, to the AC power plug of the main body. The upstream DC power supply path 50 is also connected to the operation panel 2 via connection parts 300. When the main body control unit 10 is supplied with the upstream DC power supply path 50, the abnormality display unit 25a (first display unit), the abnormality display unit 25b (second display unit), and the connection display unit 26 become operative. The statuses of these units are displayed through the LED emission as represented by an example of an electric circuit illustrated in FIG. 6. When the main body power switch 121 is OFF, the downstream DC power supply path 51 is disconnected by a switch control unit 40, disabling system operations.

FIG. 6 illustrates an example of an electric circuit used in the abnormality display unit 25a (first display unit), the abnormality display unit 25b (second display unit), and the connection display unit 26. The circuits of respective display units are equivalent, and thus the abnormality display unit 25a (first display unit) will be described below as a representative display unit. The abnormality display unit 25a (first display unit) is connected to the upstream DC power supply path 50.

An LED 61 is a light emitting element that emits light when supplied with an electric current. When the main body power switch 121 is OFF, the CPU 100 does not operate, and a signal line 60 is not controlled (for example, in the high impedance state). Accordingly, the logic of the signal line 60 connected to the base of a transistor 63 is fixed to Low, and the transistor 63 is in the OFF state where no current flows between the collector and the emitter. The base of a transistor 64 is applied with the voltage by the upstream DC power supply path 50. Thus, when the transistor 63 is OFF, the transistor 64 is in the ON state where a current flows between the collector and the emitter. Therefore, when the main body power switch 121 is OFF and the upstream DC power supply path 50 is properly supplied by the power source device 12, the LED 61 is caused to be in a state where the LED 61 emits light (conductive state) by the current value adjusted by a resistor 62. The resistor 62 is a chip or lead resistor used on electric circuits. The constant of the resistor 62 differs according to the position at which it is used, in other words, the constant to be used at different positions is not common. The constant is to be considered for each system to which the constant is applied and is not limited, and the description thereof will be omitted.

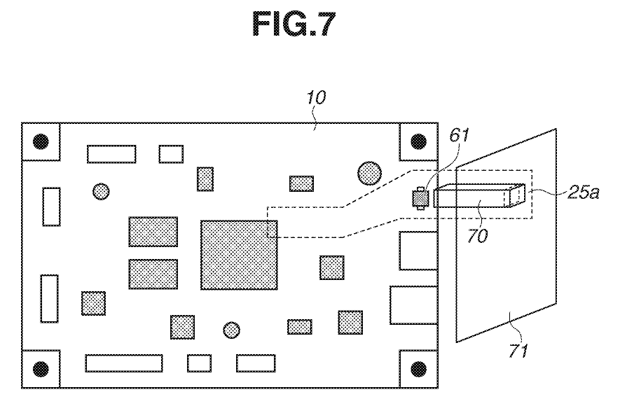

FIG. 7 illustrates an overview of an electric substrate configuring the main body control unit 10 and an example configuration of the abnormality display unit 25a (first display unit). Like FIG. 6, the abnormality display unit 25a (first display unit) will be described below as a representative display unit.

The LED 61 is mounted inside the image forming apparatus 1 and therefore cannot be immediately visually checked by the user. The housing may be configured to enable the user to easily access the inside of the image forming apparatus 1, however, an example where the LED 61 can be visually checked from outside will be described below. The abnormality display unit 25a (first display unit) is installed outside a housing cover 71 of the image forming apparatus 1 (outside the main body) through a light guide 70 for transmitting the light emission of the LED 61 to the outside. This configuration allows the user to immediately visually check the status if an abnormality occurs.

Referring back to FIG. 5, when the main body power switch 121 is turned ON, the switch control unit 40 connects the upstream DC power supply path 50 to the downstream DC power supply path 51. This turns ON the power of the CPU 100 of the main body control unit 10 and the CPU 200 of the operation panel 2, activating system operations.

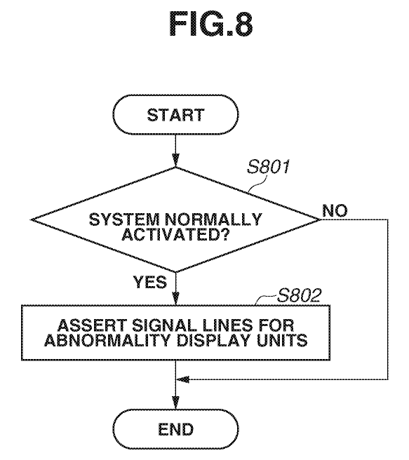

FIG. 8 is a flowchart illustrating processing on the signal line 60 that activates the abnormality display unit 25a (first display unit) and the abnormality display unit 25b (second display unit) when system operations start. The processing of the flowchart in FIG. 8 is implemented when the CPU 100 loads the programs 110 stored in the storage device 11 included in the main body control unit 10, into the memory 101, and executes the programs 110. Likewise, the CPU 200 of the operation panel 2 loads the programs stored in the ROM 201 into the RAM 202 and executes the programs. Since the processing is common to these display units, a single processing flowchart for the abnormality display unit 25a (first display unit) will be described below. The processing of the image forming apparatus 1 will be described below.

In step S801, the CPU 100 determines whether the system has been normally activated. If the system is not normally activated, the processing exits the flowcharts in FIG. 8. If the system has been normally activated, the processing proceeds to step S802.

In step S802, the CPU 100 asserts the signal line 60 for controlling the abnormality display unit 25a (first display unit) to High. In this state, no current flows between the collector and the emitter of the transistor 64 illustrated in FIG. 6, and the LED 61 turns OFF (i.e., emit light).

In this system, the abnormality display unit 25a (first display unit) in the OFF state indicates that the system is normally operating. If the system is not normally activated (NO in step S801), the signal line 60 does not operate and remains Low. The system cannot perform processing any more and the processing exits the flowchart.

In this case, the LED 61 remains ON indicating the power OFF state or an abnormal state at the activation time. Since the unit of each electric circuit is supplied with the upstream DC power supply path 50 via the connection parts 300, each electrical circuit can independently determine the normal activation. Further, the abnormality display unit 25a (first display unit) and the abnormality display unit 25b (second display unit) are ON when the system is OFF. With this configuration, if the abnormality display unit 25b (second display unit) past the connection parts 300 is OFF, for example, the possibility of an abnormality of the connection parts 300 can be detected even when the system does not start.

The image forming apparatus 1 as an example of an information processing apparatus includes the image forming unit 15 for forming an image on a sheet illustrated in FIG. 3.

As illustrated in FIG. 5, the CPU 100 serves as a main body control unit system circuit and is connected to the first power supply path 51. The CPU 200 serves as an operation panel system circuit and is connected to the first power supply path 51 and also connected to the CPU 100 via the connection signal line 30. The CPU 200 is connected to the CPU 100 via the connection parts 300.

The first power supply path 51 is connected to the power source device 12 when the main body power switch 121 is ON, and is not connected thereto when the main body power switch 121 is OFF. A second power supply path 50 is connected to the power source device 12 regardless of whether the main body power switch 121 is ON or OFF. The display unit 21 is connected to the first power supply path 51 and the CPU 200.

As illustrated in FIGS. 6 and 7, for example, each of the abnormality display unit 25a and the abnormality display unit 25b include the LED 61, and the light guide 70 for guiding the display of the LED 61 to make the display visible to the outside of the image forming apparatus 1.

Referring to FIG. 5, the abnormality display unit 25a (first display unit) connected to a second power supply path 50 different from the first power supply path 51 performs display when the CPU 100 is not activated, and cancels the display when the CPU 100 is activated. The abnormality display unit 25b (second display unit) connected to the second power supply path 50 performs display when the CPU 200 is not activated, and cancels the display when the CPU 200 is activated.

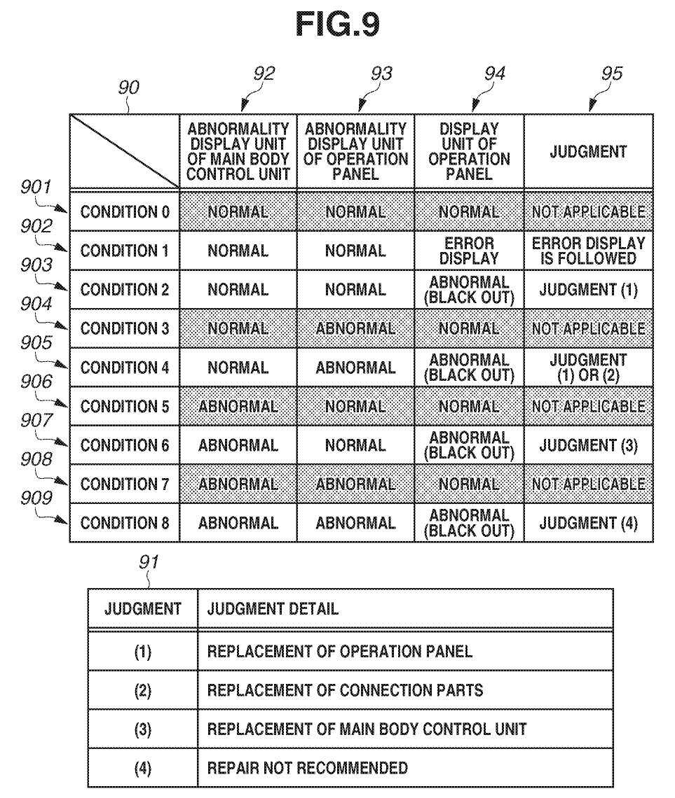

Criteria for determining which replacement part is to be selected if the user finds a failure, by using the above-described electric circuit and processing flowchart, will be described below with reference to FIG. 9. Table 90 in FIG. 9 illustrates statuses of the abnormality display unit 25a (first display unit) of the main body control unit 10, statuses of the abnormality display unit 25b (second display unit) and the display unit 21 of the operation panel 2.

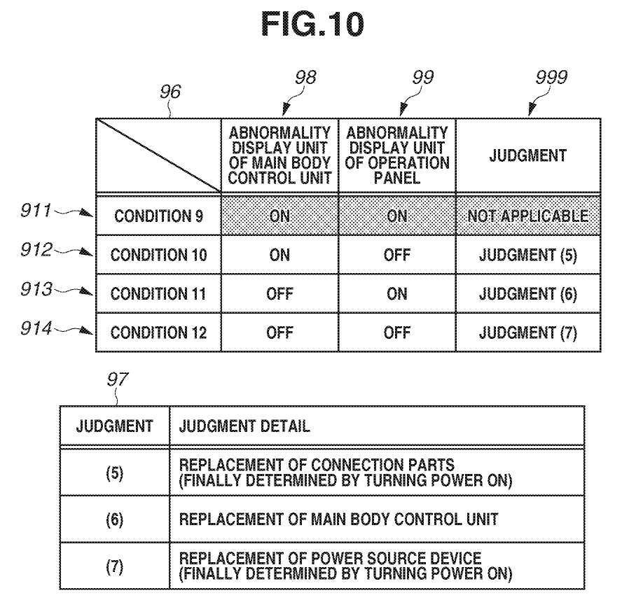

Table 91 illustrates details of judgments derived from the statuses in Table 90. Tables 90 and 91 illustrate judgments to be applied in a state where the main body power switch 121 is ON. These tables are on the premise that, when the main body power switch 121 is OFF, both the abnormality display unit 25a (first display unit) and the abnormality display unit 25b (second display unit) are ON. Judgments to be applied if an abnormality occurs when the main body power switch 121 is OFF are illustrated in FIG. 10.

A column 92 indicates the statuses of the abnormality display unit 25a (first display unit) of the main body control unit 10. A column 93 indicates the statuses of the abnormality display unit 25b (second display unit) of the operation panel 2. A column 94 indicates the statuses of the display unit 21 of the operation panel 2. A column 95 indicates examples of judgments.

For a row 901 (Condition 0), all of the display units are normal, and therefore the abnormality judgment is "Not Applicable".

For a row 902 (Condition 1), an error message is assumed to be displayed on the display unit 21 of the operation panel 2. This error display is different from the abnormal state indicated by this system. The user takes measures following the instruction specified by the error message. Details on error messages will be omitted.

For a row 903 (Condition 2), the abnormality display unit 25a (first display unit) of the main body control unit 10 is normal (OFF), the abnormality display unit 25b (second display unit) of the operation panel 2 is normal (OFF), and the display unit 21 of the operation panel 2 is abnormal (disabled screen display or black out). Since the system of the operation panel 2 has been normally activated and the abnormality display unit 25b (second display unit) has been normalized, the display unit 21 is determined to have become defective. The abnormality judgment is Judgment (1) which leads to the replacement of the operation panel 2 including the display unit 21.

For a row 904 (Condition 3), there is assumed no case where the display unit 21 normally performs display in a state where the operation panel 2 cannot be supplied with power. Therefore, the abnormality judgment is "Not Applicable".

For a row 905 (Condition 4), the abnormality display unit 25b (second display unit) of the operation panel 2 is not released by system operations. Accordingly, the abnormality judgment is Judgment (1) which leads to the replacement of the operation panel 2 including the system portion of the operation panel 2. However, if the abnormality display unit 25b (second display unit) is OFF when the main body power switch 121 is OFF, the abnormality judgment is Judgment (2) which leads to the replacement of the connection parts 300.

For a row 906 (Condition 5), there is assumed no case where the display unit 21 of the operation panel 2 normally performs display in a state where the main body control unit 10 does not operate. Therefore, the abnormality judgment is "Not Applicable". This is because, according to the present embodiment, the main body control unit 10 finally specifies the content to be displayed on the display unit 21.

For a row 907 (Condition 6), the abnormality display unit 25a (first display unit) of the main body control unit 10 is abnormal (ON), the abnormality display unit 25b (second display unit) of the operation panel 2 is normal (OFF), and the display unit 21 of the operation panel 2 is abnormal (disabled screen display or black out). This is determined to be a state where the main body control unit 10 is not normally operating and the display unit 21 is not displaying anything although the operation panel 2 is supplied with power and the system operation is possible. The abnormality judgment is Judgment (3) which leads to the replacement of the main body control unit 10.

For a row 908 (Condition 7), there is assumed no case where the display unit 21 is normal in a state where all of the control units are abnormal. Therefore, the abnormality judgment is "Not Applicable".

For a row 909 (Condition 8), the abnormality display unit 25a (first display unit) of the main body control unit 10 is abnormal (ON), the abnormality display unit 25b (second display unit) of the operation panel 2 is abnormal (ON), and the display unit 21 of the operation panel 2 is abnormal (disabled screen display or black out). Since the ON state can be confirmed, the power source device 12 is normally operating, and the connection parts 300 are normally connected. A case where both systems fail is very rare. The abnormality judgment is close to "Not Applicable", and the abnormality judgment is Judgment (4) which does not recommend repair but desirably recommends the inspection and replacement of the image forming apparatus 1.

FIG. 9 illustrates a judgment table to be applied in a state where the main body power switch 121 is ON. FIG. 10 illustrates a judgment table to be applied in a state where the main body power switch 121 is OFF, which serves as a supplementary table for the tables in FIG. 9. Table 96 in FIG. 10 indicates the ON/OFF statuses of the LED of the abnormality display unit 25a (first display unit) of the main body control unit 10 and the LED of the abnormality display unit 25b (second display unit) of the operation panel 2. Table 97 illustrates details of judgments derived from the statuses in Table 96. Except for certain cases, the final trouble state is determined after the main body power switch 121 is turned ON.

A column 98 indicates the statuses of the abnormality display unit 25a (first display unit) of the main body control unit 10. A column 99 indicates the statuses of the abnormality display unit 25b (second display unit) of the operation panel 2. Since the main body power switch 121 is OFF and is connected to no system path, Table 96 includes no column for the display unit 21 of the operation panel 2. A column 999 indicates examples of judgments.

For a row 911 (Condition 9), all of the display units are normal, and therefore the abnormality judgment is "Not Applicable".

For a row 912 (Condition 10), the abnormality display unit 25a (first display unit) of the main body control unit 10 is ON, and the abnormality display unit 25b (second display unit) of the operation panel 2 is OFF. The abnormality judgment is Judgment (5), and the replacement of connection parts 300 is suspected. However, since an internal failure of the operation panel 2 may possibly have occurred, the final trouble state is determined after the main body power switch 121 is turned ON.

For a row 913 (Condition 11), the abnormality display unit 25a (first display unit) of the main body control unit 10 is OFF, and the abnormality display unit 25b (second display unit) of the operation panel 2 is ON. The operation panel 2 is supplied with power via the connection parts 300. The abnormality judgment is Judgment (6), and a failure of the main body control unit 10 is suspected. Since an internal failure of the operation panel 2 may possibly have occurred, the final trouble state is determined after the main body power switch 121 is turned ON.

For a row 914 (Condition 12), the abnormality display unit 25a (first display unit) of the main body control unit 10 is OFF, and the abnormality display unit 25b (second display unit) of the operation panel 2 is OFF. Since none of the display units may be supplied with power, the abnormality judgment is Judgment (7), and the replacement of the power source device 12 is suspected. However, since an internal failure of the main body control unit 10 or the operation panel 2 may possibly have occurred, the final trouble state is determined after the main body power switch 121 is turned ON.

In this way, a method for supplying the upstream DC power supply path 50 different from the downstream DC power supply path 51 to each unit (the main body control unit 10 and the operation panel 2 according to the present embodiment) of the image forming apparatus 1 to identify system operations and connection statuses can be implemented. The present embodiment enables assisting service engineers and users to suitably identify defective portions and correctly select replacement parts. The technique according to the present specification can contribute to the realization of a sustainable society such as a decarbonized/recycle-based society.

### Second Embodiment

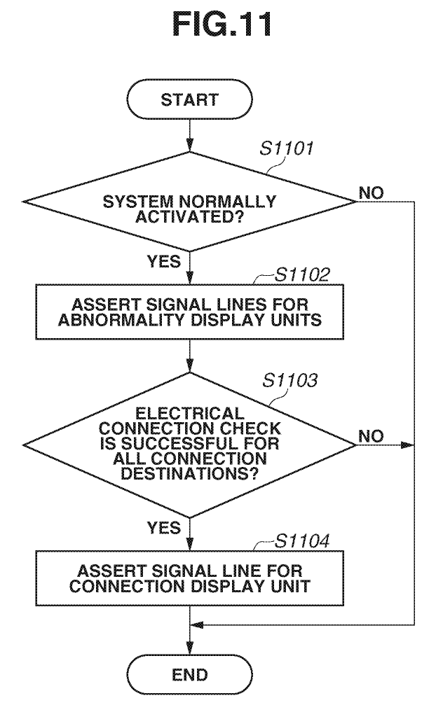

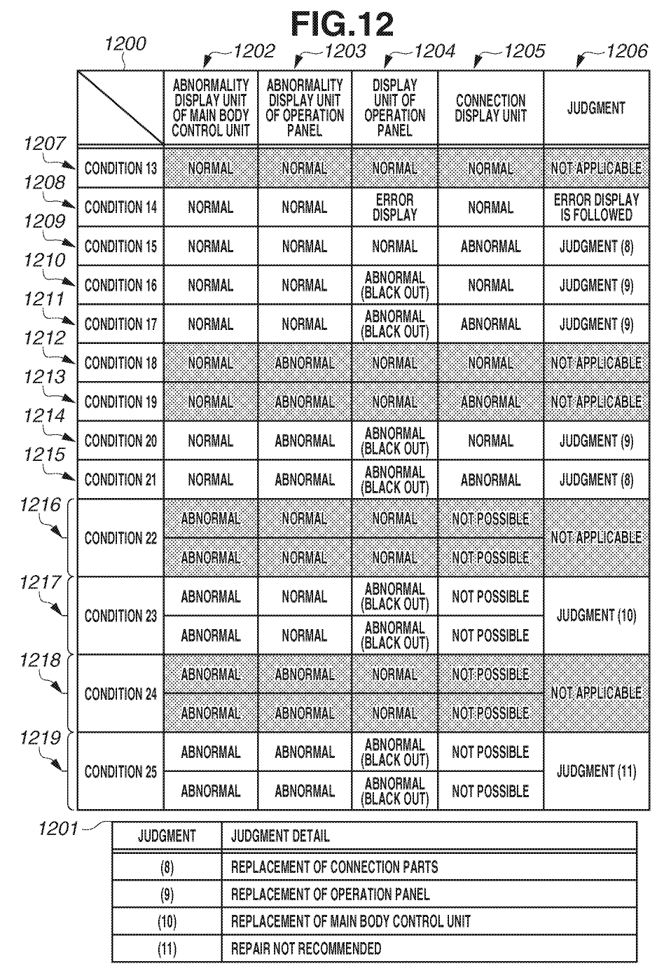

The electric circuit configuring the image forming apparatus 1 according to a second embodiment and the processing of the circuit will be described below with reference to the configuration of the first embodiment and FIGS. 11 and 12.

The first embodiment determines fault statuses of the connection parts 300 based on the power supply of the upstream DC power supply path 50. The second embodiment is based on the increased number of determination factors to enable the selection of replacement parts in consideration of partial disconnections, by using the connection signal line 30. Descriptions of common components will be omitted.

FIG. 11 is a flowchart illustrating processing for the signal line 60 that activates the abnormality display unit 25a (first display unit), the abnormality display unit 25b (second display unit), and the connection display unit 26 when system operations start. The processing of the flowchart in FIG. 11 is implemented when the CPU 100 loads the programs 110 stored in the storage device 11 of the main body control unit 10 into the memory 101 and then executes the programs.

In step S1101, the CPU 100 determines whether the system has been normally activated as in step S801. If the system has been normally activated, the processing proceeds to step S1102.

In step S1102, the CPU 100 asserts the signal line 60 for controlling the abnormality display unit 25a (first display unit) to High. Then, the processing proceeds to step S1103.

If the system is not normally activated (NO in step S1101), the signal line 60 does not work or remains Low. Since further processing is not possible, the processing exits the flowchart.

In step S1103, the CPU 100 checks the electrical continuity of the power lines of the upstream DC power supply path 50 and the downstream DC power supply path 51 to the operation panel 2, and the electrical continuity of the connection signal line 30 to be used. As illustrated in FIG. 5, a predetermined voltage is applied to the connection signal line 30 (the CPU 100 can detect the High level) via a resistor 52 at the operation panel 2, which is the power supply destination. Before the connection signal line 30 is operated for its intended purpose of communicating with the operation panel 2, the CPU 100 causes the connection signal line 30 to operate as an input signal line and detects the predetermined voltage, thereby determining whether the connection is intact.

The CPU 100 performs this check for the number of signal lines. If the electrical connection is successful for all signal lines (YES in step S1103), the processing proceeds to step S1104.

In step S1104, the CPU 100 asserts the signal line 60 for controlling the connection display unit 26 to High. This control of the connection display unit 26 is similar to the control of the abnormality display unit 25a (first display unit). The LED 61 illustrated in FIG. 6 is OFF, indicating that the connection parts 300 are normal.

If the electrical connection of any one of the connection signal lines 30 is abnormal (NO in step S1103), the signal line 60 does not operate, i.e., remains Low, and the processing exits the flowchart.

This configuration provides information that enables determination of partial faults of the connection parts 300 such as in a case where the main body control unit 10 does not communicate via the connection signal line 30 and no error message can be displayed on the display unit 21 even after the operation panel 2 has been normally activated.

Referring to FIG. 11, the connection display unit 26 connected to the second power supply path 50 performs display in a state where the CPU 100 is not activated and cancels display if the CPU 100 determines that the electrical connection of the connection signal line 30 is normal.

Criteria for determining which replacement part is to be selected if the user finds a failure, by using the above-described electric circuit and processing flow, will be described below with reference to FIG. 12. Table 1200 in FIG. 12 indicates the statuses of the abnormality display unit 25a (first display unit) and the connection display unit 26 of the main body control unit 10, and the statuses of the abnormality display unit 25b (second display unit) and the display unit 21 of the operation panel 2.

Table 1201 illustrates details of judgments derived from the statuses in Table 1200. Like the tables in FIG. 9, Tables 1200 and 1201 illustrate the judgments to be used in a state where the main body power switch 121 is ON.

These tables are on the premise that, when the main body power switch 121 is OFF, the abnormality display unit 25a (first display unit), the abnormality display unit 25b (second display unit), and the connection display unit 26 are ON.

A column 1202 indicates the statuses of the abnormality display unit 25a (first display unit) of the main body control unit 10.

A column 1203 indicates the statuses of the abnormality display unit 25b (second display unit) of the operation panel 2. A column 1204 indicates the statuses of the display unit 21 of the operation panel 2. A column 1205 indicates the statuses of the connection display unit 26 of the main body control unit 10. A column 1206 indicates examples of judgments.

For a row 1207 (Condition 13), all of the display units are normal, and therefore the abnormality judgment is "Not Applicable".

For a row 1208 (Condition 14), an error message is assumed to be displayed on the display unit 21. This error display is different from the abnormal state indicated by this system. The user takes measures following the instruction specified by the error message. Details on error messages will be omitted.

For a row 1209 (Condition 15), the abnormality display unit 25a (first display unit) is normal (OFF), the abnormality display unit 25b (second display unit) is normal (OFF), the display unit 21 is normal, and the connection display unit 26 is abnormal (ON). Although the connection display unit 26 indicates an abnormality, the display unit 21 of the operation panel 2 normally performs display, and hence a partial disconnection is assumed to have occurred. Therefore, the abnormality judgment is Judgment (8) which leads to the replacement of connection parts 300.

For a row 1210 (Condition 16), the abnormality display unit 25a (first display unit) is normal (OFF), the abnormality display unit 25b (second display unit) is normal (OFF), the display unit 21 is abnormal (disabled screen display or black out), and the connection display unit 26 is normal (OFF). Since the display unit 21 is determined to have become defective, the abnormality judgment is Judgment (9) which leads to the replacement of the operation panel 2 including the display unit 21.

For a row 1211 (Condition 17), the abnormality display unit 25a (first display unit) is normal (OFF), the abnormality display unit 25b (second display unit) is normal (OFF), the display unit 21 is abnormal (disabled screen display or black out), and the connection display unit 26 is abnormal (ON). Although the system of the operation panel 2 is normally operating, a partial disconnection is assumed to have occurred. The abnormality judgment is Judgment (8) which leads to the replacement of connection parts 300.

For a row 1212 (Condition 18), there is assumed no case where the display unit 21 of the operation panel 2 normally performs display in a state where the operation panel 2 does not operate. Therefore, the abnormality judgment is "Not Applicable".

For a row 1213 (Condition 19), like the row 1212, there is assumed no case where the display unit 21 of the operation panel 2 normally performs display in a state where the operation panel 2 does not operate. Therefore, the abnormality judgment is "Not Applicable".

For a row 1214 (Condition 20), the abnormality display unit 25a (first display unit) is normal (OFF), the abnormality display unit 25b (second display unit) is abnormal (ON), the display unit 21 is abnormal (disabled screen display or black out), and the connection display unit 26 is normal (OFF). The operation panel 2 is inoperative, and the display unit 21 does not perform display. The abnormality judgment is Judgment (9) which leads to the replacement of the operation panel 2.

For a row 1215 (Condition 21), the abnormality display unit 25a (first display unit) is normal (OFF), the abnormality display unit 25b (second display unit) is abnormal (ON), the display unit 21 is abnormal (disabled screen display or black out), and the connection display unit 26 is abnormal (ON). For this condition, the operation panel 2 is inoperative, and the display unit 21 does not perform display. Since the connection determination is also abnormal, the abnormality of the operation panel 2 is assumed to be caused by a fault of the connection parts 300. Therefore, the abnormality judgment is Judgment (8) which leads to the replacement of the connection parts 300.

This completes descriptions of a case where system operations of the main body control unit 10 are normal. In the following cases, system operations of the main body control unit 10 are abnormal, and the processing flow for checking the electrical continuity of the connection signal line 30 illustrated in FIG. 11 is not executed. In this case, the column 1205 is "Not Possible". Therefore, abnormal system operations of the main body control unit 10 are classified into four categories, not eight categories.

For a row 1216 (Condition 22), there is assumed no case where the display unit 21 of the operation panel 2 normally performs display in a state where the main body control unit 10 does not operate. Therefore, the abnormality judgment is "Not Applicable". This is because, according to the present embodiment, the main body control unit 10 specifies the contents to be finally displayed on the display unit 21.

For a row 1217 (Condition 23), the abnormality display unit 25a (first display unit) is abnormal (ON), the abnormality display unit 25b (second display unit) is normal (OFF), and the display unit 21 is abnormal (disabled screen display or black out). This is determined to be a state where the main body control unit 10 is not normally operating and the display unit 21 is not displaying anything although the operation panel 2 is supplied with power and the system operation is possible. The abnormality judgment is Judgment (10) which leads to the replacement of the main body control unit 10.

For a row 1218 (Condition 24), there is assumed no case where the display unit 21 is normal in a state where all of the control units are abnormal. Therefore, the abnormality judgment is "Not Applicable".

For a row 1219 (Condition 25), the abnormality display unit 25a (first display unit) of the main body control unit 10 is abnormal (ON), the abnormality display unit 25b (second display unit) of the operation panel 2 is abnormal (ON), and the display unit 21 is abnormal (disabled screen display or black out). Since the ON state can be confirmed, the power source device 12 is normally operating and the connection parts 300 are normally connected. A case where both systems fail is very rare. The abnormality judgment is close to "Not Applicable", i.e., Judgment (11) which does not recommend repair but desirably recommends the inspection and replacement of the image forming apparatus 1.

Unlike the first embodiment, the second embodiment additionally performs the connection determination based on the connection signal line 30 and increases the number of determination factors. The second embodiment does not need to determine the situation like the row 905 in FIG. 9 according to the first embodiment, enabling more reliable selection of replacement parts.

The present embodiment enables assisting service engineers and users to suitably identify defective portions and correctly select replacement parts. The technique according to the present specification can contribute to the realization of a sustainable society such as a decarbonized/recycle-based society.

As described above, the first and the second embodiments provide a line for supplying an independent power source different from the power source for supplying power at the connection destination to each electrical component unit (electric substrate and connection parts) included in the image forming apparatus 1. This configuration enables identifying such a reason as a power supply failure, a system operation failure, and disconnection. This makes it possible to provide a mechanism for assisting the selection of replacement parts.

The first and the second embodiments enable assisting service engineers and users to suitably identify defective portions of each electrical component unit (electric substrate and connection parts) configuring the image forming apparatus 1 and correctly select replacement parts. The first and the second embodiments enable repair and maintenance operations through the replacement of electrical component units (electric substrate and connection parts) configuring the image forming apparatus 1.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-055695, filed Mar. 28, 2025, which is hereby incorporated by reference herein in its entirety.

What is claimed is:

1. An information processing apparatus comprising:
a first system circuit configured to be connected to a first power supply path;
a second system circuit configured to be connected to the first power supply path and configured to be connected to the first system circuit via a signal line;
a first display unit configured to be connected to a second power supply path different from the first power supply path, and configured to perform display in a state where the first system circuit is not activated and cancel display in a state where the first system circuit is activated; and
a second display unit configured to be connected to the second power supply path, and configured to perform display in a state where the second system circuit is not activated and cancel display in a state where the second system circuit is activated.

2. The information processing apparatus according to claim 1,
wherein the first power supply path is connected to a power source device in a case where a power switch is ON, and is not connected to the power source device in a case where the power switch is OFF, and
wherein the second power supply path is connected to the power source device regardless of whether the power switch is ON or OFF.

3. The information processing apparatus according to claim 1, further comprising a third display unit configured to be connected to the first power supply path and the second system circuit.

4. The information processing apparatus according to claim 1, further comprising a fourth display unit configured to be connected to the second power supply path, and configured to perform display in a state where the first system circuit is not activated and cancel display in a case where the first system circuit determines that an electrical connection of the signal line is normal.

5. The information processing apparatus according to claim 1, further comprising:
a third display unit configured to be connected to the first power supply path and the second system circuit; and
a fourth display unit configured to be connected to the second power supply path, and configured to perform display in a state where the first system circuit is not activated and cancel display in a case where the first system circuit determines that an electrical connection of the signal line is normal.

6. The information processing apparatus according to claim 1, wherein the second system circuit is connected to the first system circuit via connection parts.

7. The information processing apparatus according to claim 1, wherein the first and the second display units include a light emitting diode (LED).

8. The information processing apparatus according to claim 1, wherein the first and the second display units are configured to guide display via a light guide to make the display visible to the outside of the information processing apparatus.

9. The information processing apparatus according to claim 1,
wherein the first system circuit is a first central processing unit (CPU), and
wherein the second system circuit is a second CPU.

10. The information processing apparatus according to claim 1, further comprising an image forming unit configured to form an image on a sheet.

11. A processing method of an information processing apparatus comprising:
a first system circuit configured to be connected to a first power supply path; and
a second system circuit configured to be connected to the first power supply path and configured to be connected to the first system circuit via a signal line,
the method comprising:
first displaying in which a first display unit connected to a second power supply path different from the first power supply path performs display in a state where the first system circuit is not activated, and cancels display in a state where the first system circuit is activated; and
second displaying in which a second display unit connected to the second power supply path performs display in a state where the second system circuit is not activated, and cancels display in a state where the second system circuit is activated.
